(19) United States
(12) Patent Application Publication
(10) Pub. No.: US 2010/0039360 A1
(43) Pub. Date: Feb. 18, 2010

(54) LIQUID CRYSTAL DISPLAY AND OPERATING METHOD THEREOF

(75) Inventor: YI-PING LEE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/406,954

(22) Filed: Mar. 18, 2009

(30) Foreign Application Priority Data
Aug. 14, 2008 (CN) 200810303768.0

(51) Int. Cl. G09G 3/36

(52) U.S. Cl. 345/88; 345/87

(57) ABSTRACT

An LCD display system includes a register, a driver, and a processor. The register temporarily stores display parameter data. The driver reads the data. The processor triggers display parameter data and includes a parameter-setting module, a determination module, and a reset module. The parameter-setting module sets display parameter data. The determination module determines whether an interval during which the data of the display parameters changes exceeds a preset value. The reset module resets the display parameter data.

### BACKGROUND

1. Technical Field

The disclosure relates to a liquid crystal display (LCD) and, specifically, to an LCD system and operating method thereof.

2. Description of the Related Art

Current electronic displays such as liquid crystal displays (LCDs) are widely used. The electronic displays are easily affected by external electric or magnetic fields, especially to electrostatic discharge. Data of the display characteristics, such as color, brightness, and/or contrast, is stored in a register and initialized when booting and maintained until reset manually. An electromagnetic spark from an electrostatic discharge may falsify the data of the register, such that the characteristics are altered. Therefore, to maintain these characteristics, manual resetting is required, representing considerable inconvenience.

Therefore, it is desirable to provide an LCD and an operating method thereof which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the LCD and operating method. Moreover, in the drawings, like reference numerals designate corresponding parts throughout the several views.

FIG. 1 is a block diagram of an LCD system according to the disclosure.

FIG. 2 is a block diagram of a processor of the LCD system of FIG. 1, according to the disclosure.

FIG. 3 is a flowchart of an operating method for an LCD system, according to the disclosure.

### DETAILED DESCRIPTION OF THE EMBODIMENT

Embodiments of the LCD and operating method are described in detail here with reference to the drawings.

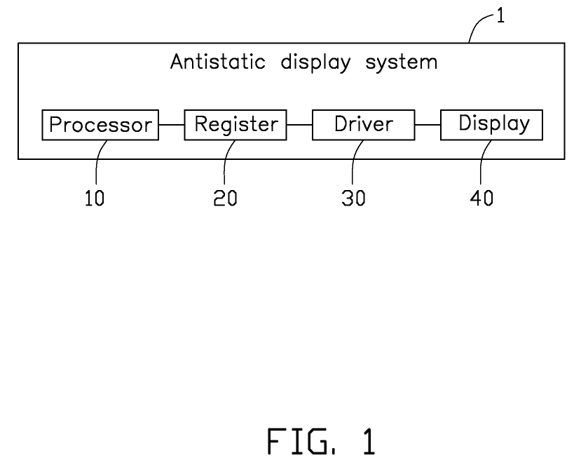

As shown in FIG. 1, an LCD system 1 includes a processor 10, a register 20, a driver 30, and a display 40. The display 40 can be a liquid crystal display (LCD) or an organic light-emitting diode (OLED) display. Here, as an example, the display 40 is an LCD.

The register 20 temporarily stores display parameter data, such as color, brightness, and contrast.

The driver 30 reads the display parameter data and renders the image on the display 40 accordingly.

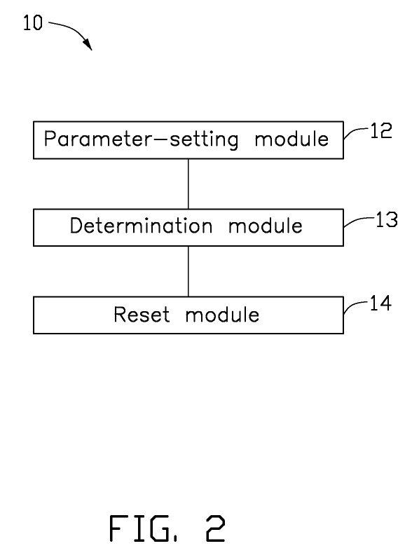

As shown in FIG. 2, the processor 10 includes a parameter-setting module 12, a determination module 13, and a reset module 14.

The parameter-setting module 12 changes the display parameter data stored in the register 20 when the display 40 is initialized.

The determination module 13 determines whether an interval during which the display parameter data in the register 20 exceeds a preset value. Flicker caused by the electrostatic discharge (ESD) can be prevented by the interval being less than average human persistence of vision. The preset value, here as an example, is less than 1/30 second.

The reset module 14 resets the register 20.

The LCD system 1 of the present embodiment, when tested using an ESD gun, maintained stable operation within −5.0˜5.0 kV, a range of tolerance considerably broadened beyond the −2.5˜1.5 kV range tolerated by a currently used display system undergoing the same testing.

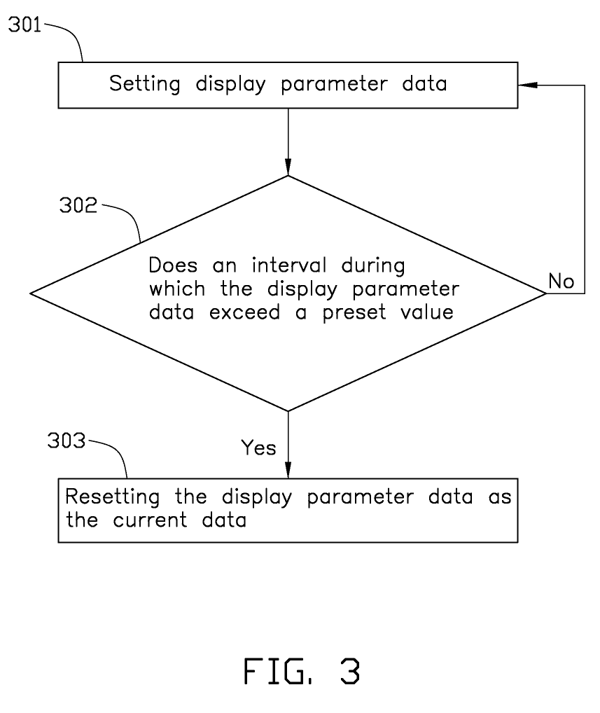

FIG. 3 shows a disclosed operating method which may be performed by, for example, the LCD system 1 of FIG. 1.

In step 301, display parameter data is set in the register 20. The data can be color, brightness, and contrast values.

In step 302, it is determined whether an interval during which the display parameter data in the register 20 exceeds a preset value, here, as an example, of less than 1/30 second. If so, step 303 is executed. If not, step 301 is executed.

In step 303, the display parameter data is reset as the current data.

The disclosed LCD display system 1 is reset within an interval compliant with the preset value, allowing the display 40 to recover the original display within the limits of average human persistence of vision. Stable and uninterrupted display is thus provided despite the ESD event.

While the disclosure has been described by way of example and in terms of preferred embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

It is also to be understood that above description and the claims drawn to a method may include some indication in reference to certain steps. However, the indication used is only to be viewed for identification purposes and not as a suggestion as to an order for the steps.

What is claimed is:

1. A liquid crystal display system, comprising:
a register that stores display parameter data;
a driver capable of reading the display parameter data; and
a processor capable of triggering the display parameter data and comprising:
a parameter-setting module capable of changing the display parameter data;
a determination module capable of determining whether an interval during which the data of the display parameters changes exceeds a preset value; and
a reset module capable of resetting the display parameter data.

2. The LCD system of claim 1, wherein the display parameter data comprise color, brightness, and contrast values.

3. The LCD system of claim 1, wherein the preset value corresponds to the average human persistence of vision.

4. The LCD system of claim 3, wherein the preset value is 1/30 second.

5. An operating method for a liquid crystal display, comprising:
changing display parameter data;
determining if an interval during which the display parameter data changes exceeds a preset value; and
upon the condition the display parameter data changes exceeds the preset value, resetting the display parameter data.

6. The operating method of claim 5, wherein the display parameter data is increased if the interval is less than the preset value.

7. The operating method of claim 5, wherein the display parameter data comprise color, brightness, and contrast conditions.

8. The operating method of claim 5, wherein the preset value is within a time frame of human visual response.

9. The operating method of claim 5, wherein the preset value is 1/30 second.
